(19) United States
(12) Patent Application Publication
(10) Pub. No.: US 2010/0310900 A1
(43) Pub. Date: Dec. 9, 2010

(54) ULTRAVIOLET-DULL RESPONSE IN SECURITY TAGGANTS

(75) Inventor: Nabil M. Lawandy, Saunderstown, RI (US)

Correspondence Address: K&L Gates LLP, STATE STREET FINANCIAL CENTER, One Lincoln Street, BOSTON, MA, 02111-2950, US

(73) Assignee: SPECTRA SYSTEMS CORPORATION, Providence, RI (US)

(21) Appl. No.: 12/794,456

(22) Filed: Jun. 4, 2010

Related U.S. Application Data
(60) Provisional application No. 61/184,586, filed on Jun. 5, 2009.

(51) Int. Cl. B32B 9/00; F21V 9/04

(52) U.S. Cl. 428/690; 252/588; 428/702; 977/774

(57) ABSTRACT

Articles and methods for manufacturing security articles include ultraviolet absorptive materials disposed above and below an emissive security taggant that prevent excitation of the taggant itself at certain shorter ultraviolet wavelengths, rendering the article secure from detection by normal or conventional means.

### CROSS-REFERENCE TO RELATED APPLICATIONS

This application claims the benefit of U.S. Provisional Application No. 61/184,586, filed on Jun. 5, 2009, the entire disclosure of which is incorporated by reference herein.

### FIELD OF INVENTION

The present invention relates to security articles, and more specifically to security articles having a substrate constructed with materials that exhibit an ultraviolet fluorescence or phosphorescence emission.

### BACKGROUND

Counterfeiting of documents such as passports, stock certificates, and banknotes is a serious problem in modern economies. Large scale counterfeiting is often financed by well funded organizations such as foreign governments and terrorist organizations. Counterfeiting activity poses threats to both economic stability and national security.

Public security features are usually aimed at preventing smaller scale, less sophisticated counterfeiting, while covert machine readable features known only to central banks or border control authorities are the main deterrent to sophisticated large scale efforts. Typically these features are required to be undetectable as well as extremely difficult to reproduce.

What is needed, therefore, is a security article such as a banknote or other secure document having a substrate constructed to allow for the use of materials that exhibit an ultraviolet fluorescence or phosphorescence to be employed without having this emission detectable by normal or conventional means, but rather by simple visual inspection under an appropriate ultraviolet illumination source only.

### SUMMARY

Embodiments of the invention include articles and methods for manufacturing security articles. Ultraviolet absorptive materials disposed above and below an emissive security taggant prevent the excitation of the taggant itself at certain shorter ultraviolet wavelengths, rendering the document secure from detection by normal or conventional means.

According to one embodiment of the invention, a security article includes a first substrate comprising an ultraviolet absorptive material and an emissive taggant excitable by ultraviolet radiation. The taggant may be disposed in the substrate and blocked by at least a portion of the ultraviolet absorptive material. The ultraviolet absorptive material prevents emission of the taggant upon application of substantially short ultraviolet wavelengths.

Another embodiment of the invention includes a method of manufacturing a security article in which a first substrate is embedded with an ultraviolet absorptive material. An emissive taggant excitable by ultraviolet radiation is also embedded within the substrate. The taggant is blocked by at least a portion of the ultraviolet absorptive material. The ultraviolet absorptive material prevents emission of the taggant upon application of substantially short ultraviolet wavelengths.

Yet another embodiment of the invention includes an ultraviolet-dull response structure having a first substrate and a second substrate. Each of the substrates include an ultraviolet absorptive material. An emissive taggant excitable by ultraviolet radiation is disposed between the first substrate and the second substrate. The ultraviolet absorptive material prevents emission of the taggant upon application of ultraviolet wavelengths less than about 400 nm.

### BRIEF DESCRIPTION OF THE DRAWINGS

The present invention will be more readily understood from a detailed description of the preferred embodiments taken in conjunction with the following figures:

FIG. 1 depicts a cross-sectional view of a security document in accordance with an embodiment of the present invention; and

FIG. 2 illustrates a method of creating a secure document in accordance with an embodiment of the invention.

### DETAILED DESCRIPTION

Throughout the application, where compositions are described as having, including, or comprising specific components, or where processes are described as having, including or comprising specific process steps, it is contemplated that compositions of the present teachings also consist essentially of, or consist of, the recited components, and that the processes of the present teachings also consist essentially of, or consist of, the recited process steps.

In the application, where an element or component is said to be included in and/or selected from a list of recited elements or components, it should be understood that the element or component can be any one of the recited elements or components and can be selected from a group consisting of two or more of the recited elements or components. Further, it should be understood that elements and/or features of a composition, an apparatus, or a method described herein can be combined in a variety of ways without departing from the spirit and scope of the present teachings, whether explicit or implicit herein.

The use of the terms “include,” “includes,” “including,” “have,” “has,” or “having” should be generally understood as open-ended and non-limiting unless specifically stated otherwise.

The use of the singular herein includes the plural (and vice versa) unless specifically stated otherwise. Moreover, the singular forms “a,” “an,” and “the” include plural forms unless the context clearly dictates otherwise. In addition, where the use of the term “about” is before a quantitative value, the present teachings also include the specific quantitative value itself, unless specifically stated otherwise.

It should be understood that the order of steps or order for performing certain actions is immaterial so long as the present teachings remain operable. Moreover, two or more steps or actions may be conducted simultaneously.

According to one embodiment of the invention, the optical or ultraviolet excitation of taggants such as fibers and other security features, which exhibit emissions under excitation by ultraviolet or other wavelengths, can be suppressed by placing the taggants within a region which lies inside or within one or two (for double sided suppression) other regions void of such materials. These void regions prevent the excitation light at shorter wavelengths from reaching the emissive materials through a combination of scattering and absorption. The scattering is preferential to shorter wavelengths, and in the case of Rayleigh scattering, exhibits a λ⁻⁴ dependence, where λ is the wavelength. Shorter wavelengths less than about 400 nanometers (nm) are expected to experience a six-fold (6×) increase in scattering as compared to wavelengths in the 600 nm range. This allows longer wavelength-response taggants from about 400 nm to about one micron to be interrogated by sensors while remaining dull to ultraviolet excitation. This strong dependence on wavelength favors the transmission of longer wavelengths, allowing for the interaction of other wavelengths with the taggant materials within the suppression region. In addition, according to one embodiment, the construction of a document can utilize additional materials or particles, which absorb undesirable excitation wavelengths, such as the ultraviolet excitation as is common in public security features. The absorptive materials may be organic materials, such as common ultraviolet absorbers, inorganic materials, such as TiO₂, semiconductor nanocrystals, or other oxides such as ZnO.

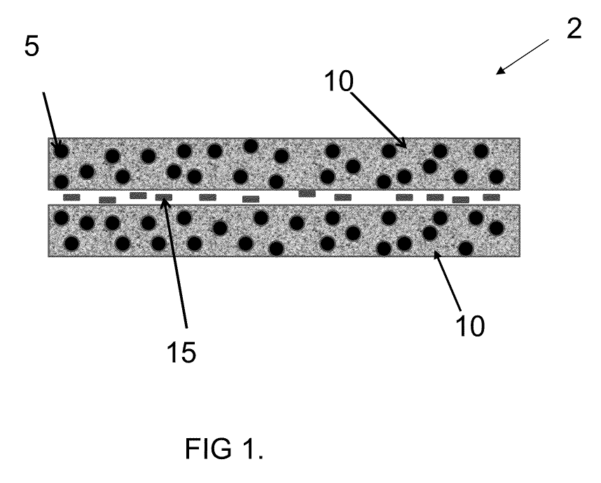

FIG. 1 depicts a cross-sectional view of a secure document 2 in accordance with an embodiment of the invention. Two scattering substrate layers 10 (e.g., paper) surround or incorporate a layer of taggant materials 15. The substrate layers 10 include particles 5 having absorptive properties in the ultraviolet or other specific wavelength ranges. The taggant materials 15 may include fibers, planchettes, or threads. The absorptive particles prevent excitation light at shorter wavelengths from reaching the emissive taggant materials contained in the substrates 10. Examples of emissive materials may include, without limitation, ultraviolet-infrared phosphors, upconverting materials, fluorescent dyes, and quantum dots.

As an additional public security feature, in one embodiment, emissive taggants, which respond to ultraviolet excitation, can be incorporated in a single layer structure whereby the fluorescence can be activated from one side of the document and not the other.

According to one embodiment, banknotes or other secure documents utilizing a double or single sided ultraviolet-dull response can be constructed by either localizing the pulp layer with the taggant in the center of the note during the forming process or through a multilayer construction process with two or three layers being pressed together to form the final substrate or document paper.

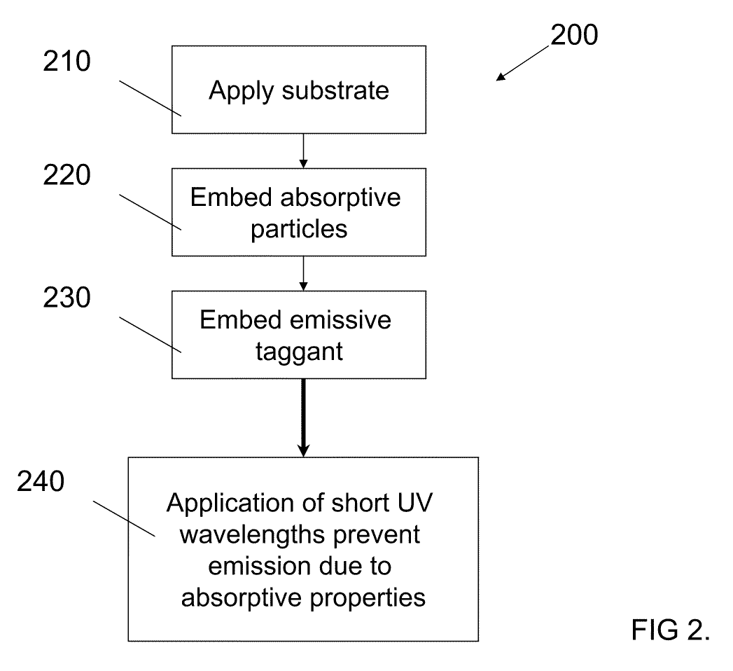

FIG. 2 illustrates a method 200 of manufacturing a secure document. According to the illustrated method, a substrate 210 is embedded 220 with ultraviolet absorptive materials. An ultraviolet emissive taggant is also embedded 230 beneath a portion of the substrate and the plurality of ultraviolet absorptive particles. Upon application of substantially short ultraviolet wavelengths to the document 240, the absorptive materials prevent emission of the taggant at those wavelengths. Only upon application or excitation of the document by a longer wavelength source will a responsive emission be detected.

While embodiments of the invention described herein use ultraviolet absorptive and emissive materials to form a security article, one skilled in the art should recognize that other materials that exhibit similar behaviors under different excitation sources may be used, such as absorptive and emissive materials in the visible light spectrum, the infrared spectrum, and other electromagnetic radiation.

While the invention has been described with reference to illustrative embodiments, it will be understood by those skilled in the art that various other changes, omissions and/or additions may be made and substantial equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A security article comprising:
a first substrate comprising a first ultraviolet absorptive material; and
an emissive taggant excitable by ultraviolet radiation disposed in the first substrate and blocked by at least a portion of the first ultraviolet absorptive material of the first substrate;
wherein the ultraviolet absorptive material prevents emission of the taggant upon application of substantially short ultraviolet wavelengths.

2. The security article of claim 1 wherein the substantially short ultraviolet wavelengths are wavelengths less than about 400 nm.

3. The security article of claim 1 wherein the first ultraviolet absorptive material is formed as a layer in the first substrate to block the taggant.

4. The security article of claim 1 wherein the taggant is selected from the group consisting of fibers, planchettes and threads.

5. The security article of claim 1 wherein the first ultraviolet absorptive material comprises an inorganic material.

6. The security article of claim 5 wherein the inorganic material is selected from the group consisting of TiO₂, ZnO, semiconductor nanocrystals and oxides.

7. The security article of claim 1 wherein the first ultraviolet absorptive material comprises a plurality of particles.

8. The security article of claim 1 where in the first ultraviolet absorptive material comprises an organic material.

9. The security article of claim 1 further comprising a second substrate comprising a second ultraviolet absorptive material, wherein the taggant is blocked by at least a portion of the second ultraviolet absorptive material of the second substrate.

10. The security article of claim 9 wherein the first ultraviolet absorptive material and the second ultraviolet absorptive material are the same ultraviolet absorptive material.

11. The security article of claim 1 where in the taggant is selected from the group consisting of ultraviolet-infrared phosphors, upconverters, fluorescent dyes, and quantum dots.

12. A method of manufacturing a security article comprising:
embedding a first ultraviolet absorptive material in a first substrate; and
embedding an emissive taggant excitable by ultraviolet radiation within the first substrate and blocked by at least a portion of the first ultraviolet absorptive material of the first substrate, the first ultraviolet absorptive material preventing emission of the taggant upon application of substantially short ultraviolet wavelengths.

13. The method of claim 12 wherein the substantially short ultraviolet wavelengths are wavelengths less than about 400 nm.

14. The method of claim 12 wherein the taggant is selected from the group consisting of fibers, planchettes and threads.

15. The method of claim 12 wherein the first ultraviolet absorptive material comprises inorganic materials.

16. The method of claim 12 wherein the ultraviolet absorptive material comprises organic materials.

17. The method of claim 12 wherein the embedding the first ultraviolet absorptive material in the first substrate comprises forming the first ultraviolet absorptive material as a layer in the first substrate to block the taggant.

18. The method of claim 12 further comprising applying a second substrate, the second substrate comprising a second ultraviolet absorptive material, wherein the taggant is blocked by at least a portion of the second ultraviolet absorptive material of the second substrate.

19. An ultraviolet-dull response structure comprising:
a first substrate and a second substrate, each comprising an ultraviolet absorptive material; and
an emissive taggant excitable by ultraviolet radiation disposed between the first substrate and the second substrate, the ultraviolet absorptive material preventing emission of the taggant upon application of ultraviolet wavelengths less than about 400 nm.
